(19) United States
(12) Patent Application Publication
(10) Pub. No.: US 2005/0186002 A1
(43) Pub. Date: Aug. 25, 2005

(54) Printing condition inspection method, a character string inspection method and an inspection apparatus using the methods

(75) Inventor: Osamu Matsutake, Kyoto-shi (JP)

Correspondence Address: FOLEY AND LARDNER;SUITE 500, 3000 K STREET NW, WASHINGTON, DC, 20007, US

(73) Assignee: Omron Corporation

(21) Appl. No.: 10/967,327

(22) Filed: Oct. 19, 2004

(30) Foreign Application Priority Data
Oct. 20, 2003 (JP) 2003-359072

(51) Int. Cl. B41J 5/30

(52) U.S. Cl. 400/63

(57) ABSTRACT

After cutting out each character from an image of a character string to be inspected, a character area Rn is set for each of the characters. The height of each character area is unified to the maximum value Y_{size} of the character height. For each of the combinations H_{0y}, H_{1y}, and so forth, of corresponding horizontal lines between character areas Rn, the accumulated value P(y) of the black pixels on the lines is determined. Further, a local maximum value is extracted from the accumulated value, and the accumulated value P(y) is added for each predetermined width along Y-axis. The minimum value of the sum is extracted. Each extracted value and the height Y_{size} of the character area Rn is compared with a predetermined threshold value thereby to determine whether a dot jam or a dot drop has occurred.

### BACKGROUND OF THE INVENTION

1. Field of the Invention

The present invention relates to a technique for conducting an inspection by picking up an image of a print such as a character string and a mark including at least a character and processing the obtained image by computer thereby to determine whether the particular character string has a print defect or not, or more in particular to a method and an apparatus for conducting an inspection on a print made by use of a predetermined number of aligned nozzles as to whether the print line of each nozzle has developed a print defect.

2. Description of the Related Art

A character string indicating the date of production, the best-before date, the product code, etc. described on the package of the processed foods or the like are generally printed by the ink jet printer. The industrial ink jet printer used for this purpose comprises a print head including a predetermined number of vertically aligned nozzles, wherein the print operation is performed while selecting a nozzle for ejecting the ink in accordance with the character to be printed (a band-shaped area where dots are printed by one nozzle is hereinafter referred to as “the print line”).

Conventionally, the inspection of a dot-printed character string is generally conducted using a pattern matching technique (Japanese Unexamined Patent Publication No. 2003-187187, hereinafter referred to as Patent Document 1).

In the case where any nozzle of the ink jet printer runs out of order while printing characters, either a defect may develop in which dots are always applied on the print line corresponding to the defective nozzle (hereinafter referred to as “the dot jam”) or a defect in which no dots are applied on the print line corresponding to the same nozzle (hereinafter referred to as “the dot drop”).

FIG. 17 shows an example of a print defect.

An example of a dot jam is shown on the left side and an example of a dot drop on the right side of the page. Each of the examples indicates a case in which a defect has developed at the upper end, the central portion and the lower end of a character string. In each of these cases, a portion defined by a thin line shows a defective portion. As the dot jam or the dot drop occurs when ink is ejected, and no print defect occurs in the space between characters.

As described in Patent Document 1, the print surface of the food package or the like is not completely flat, and therefore the character strings printed may be deformed but many of them are readable. In view of this situation, the criterion of pattern matching tends to be set in the field at a slightly lower level than required. An excessively low criterion, however, may inconveniently lead to an erroneous determination that even a character string having a defect developed over the whole print line as shown in FIG. 17 is conforming.

### SUMMARY OF THE INVENTION

This invention has been achieved in view of these problems and the object thereof is to provide a character string inspection method and apparatus for conducting the inspection on a print defect developed on each print line.

In the printing condition inspection method according to the invention, an image of a print made by use of a printing head having a plurality of nozzles is picked up, and using the image picked up, the inspection is conducted as to whether the print line of each nozzle has developed a print defect.

This method comprises: a first step for setting a processing range of a predetermined width on the image of the print in the direction along the print lines and at right angles to the print lines; a second step for setting, along the direction of the print lines, a plurality of processing areas specified by the processing range set in the first step; a third step for adjusting the position of each area set in the second step in the direction orthogonal to the print lines, based on the relative positions of the particular area and the printing range on the image and unifying the length of each area in the direction orthogonal to the print lines to the length adjusted based on the maximum range of the processing area in the direction orthogonal of the print lines; a fourth step for combining the image data for each line along the direction of the print lines having corresponding relative positions in the direction orthogonal to the print lines between the areas after adjustment in the third step, and processing each set of the image data; and a fifth step for determining whether a print defect has occurred on each print line using the result of processing each set in the fourth step.

The nozzles of the printing head are preferably aligned. Unless the print lines are superposed one on another, however, the nozzles may be arranged somewhat irregularly. This is also the case with the methods and the apparatuses described below.

The “direction of the print lines” is the one along the length of the print lines and considered the direction orthogonal to the direction in which the nozzles are arranged. The “direction orthogonal to the print lines” is defined as the direction parallel to the direction in which the nozzles are aligned. In the case where the object to be printed is a character string, the characters constituting the character string are generally printed along the print lines. Nevertheless, the relation between the character string and the printing line is not limited, and the characters can be printed in an alignment along the direction orthogonal to the printing lines.

The actual print lines, which may be deformed depending on the shape of the work, are assumed to be linear for the purpose of image processing.

In the description that follows, it is assumed that the nozzles are arranged vertically, the direction of the print lines on the image is horizontal (X-axis direction) and the direction orthogonal to the print lines is vertical (Y-axis direction). In the case where the nozzles are arranged horizontally, on the other hand, assume that the print lines are along Y-axis and the direction orthogonal to the print lines is along X-axis.

In the first step described above, the processing range of a predetermined width can be set along both x and Y-axes. This processing range, which is set to the length including the whole printing range, may alternatively be set to the length including only a part of the printing range.

In the case where the print is a character string, the length of the processing range in the direction along the character string can be set to include an arbitrary number of characters not less than one. Also, the starting point of the processing range along X-axis is not necessarily the head of the character string but may be the second or subsequent character. The processing range in the direction orthogonal to the character string (corresponding to the height or width of the character), on the other hand, is desirably set to the size always including the whole printing range.

The “printing range” is defined as the range in which the dots making up the print is distributed.

In the second step, a plurality of areas have the same length along Y-axis can be set along X-axis as processing areas specified by the processing range in each direction. In the process, the position and length of these processing areas along Y-axis are desirably set to include the printing range along y direction without fail. By projecting the image data in the processing areas along X-axis, for example, the highest and lowest printing positions of the dots can be extracted, and an area can be set with these positions at the upper and lower ends, respectively.

The length along Y-axis of each area in this stage is not necessarily unified. Instead, the length of each area can be set to include the printing range corresponding to the particular area.

On the print to be inspected according to the present invention, the dots corresponding to the same nozzle may not be aligned depending on the shape of the work printed. In the processing areas, therefore, the printing range for each line along Y-axis may be displaced.

The third step is intended to adjust the position and length of each area in accordance with the displacement of the printing range. Each area is positioned to the height corresponding to the “fluctuation” of the printing range in the particular area, and the length along Y-axis of all the areas can be unified to the maximum printing width in the processing area. As a result, the relative positions of the printing lines in the processing areas can be unified between the processing areas.

In the case where the areas are set in position, the process can be executed for setting the upper end of each area, for example, to the upper end of the printing range, or the process can be executed for setting the lower end of each area to the lower end of the printing range.

In the fourth step, the “image data for each line along the direction of the print lines” can be considered as the image data obtained by dividing each area along each line along X-axis. By the fourth step, the image data on each horizontal line in each area adjusted in the third step can be combined into sets of lines each having the same relative position in the area can be divided in such a manner that the image data on the first line make up a first set of image data, the image data on the second line make up a second set of image data, and so forth. A plurality of sets of adjacent ones of these image data can be considered to correspond to one print line.

The image data of each set can be processed in various ways. For example, the average density value for each line of the same set can be calculated. Also, after counting the number of the pixels corresponding to the dots on each line, the total count can be determined for each set.

In the fifth step, the result of processing each set is compared with a reference data determined in advance thereby to determine the presence or absence of a defect such as a dot jam or a dot drop.

In the printing condition inspection method described above, the print other than marks and characters of a predetermined size can be inspected as well as simple characters or a character string. This method makes it possible to accurately detect a defect such as a dot jam or a dot drop that has developed along one print line, even in the case where the print lines are deformed due to the shape of the work to be printed.

In the printing condition inspection method according to a preferred embodiment of the invention, in the first step described above, the input of the information for setting the processing range in the direction along the print lines (X-axis direction) is received, and the processing range is set in the direction corresponding to the input information. In the process, the setting information preferably includes the setting position (the starting point of the processing range, for example) and the width of the processing range.

In the case where a character string is to be inspected in this embodiment, the information for setting the processing range in the direction orthogonal to the character string (Y-axis direction) may be set in advance. Also, after setting the processing range in X-axis direction, the image along Y-axis in this range is searched to extract the printing range of the dots, and based on the upper and lower ends of the particular range, the processing range may be set.

A character string inspection method according to this invention is intended to pick up an image of a printed character string using a printing head having a plurality of nozzles and checking whether a print defect has occurred along the character string using the obtained image. This method comprises a first step for cutting out each character making up a character string from the image of the character string to be inspected; a second step for setting a plurality of areas, for the respective characters, having an equal length in the direction orthogonal to the character string and adjusted by the maximum length of the characters in the direction orthogonal to the character string; a third step for acquiring a plurality of projection values by executing, for each character area, the process of projecting the image data in the area along the direction of the character string and accumulating the projection values for the respective sets of the lines in correspondence with each other between the character areas in the direction orthogonal to the character string; and a fourth step for determining whether a print defect has occurred or not along the character string using each accumulated value obtained in the third step.

The “direction of the character string” can be considered the direction in which the characters making up the character string are aligned and correspond to the direction in which the characters are printed by the nozzles. Generally, the character string of this type is printed horizontally, and therefore the description is made below on the assumption that the direction of the character string is the horizontal direction (X-axis direction) and the direction orthogonal to the character string the vertical direction (Y-axis direction) Nevertheless, the direction of the character string is not limited to the direction along X-axis, and in the case where the nozzles are arranged horizontally, the direction of the character string is defined as the Y-axis direction.

Regardless of whether the character string is aligned in X-axis or Y-axis direction, the length along X-axis of the character can be considered as the “width of the character”, and the length along Y-axis of the character as the “height of the character”.

In the first step described above, each character contained in the character string can be cut out by projecting the image to be processed (hereinafter referred to as “the object image”) in each direction along X- and Y-axes. In this specification, the density or gray values of the pixels along one horizontal line or one vertical line on the image are added in the projection process, and the value after adding the gray values indicating the result of the projection is referred to as “the projection value”. In the case where the object image is a binary image, the projection process can be executed by counting the number of black or white pixels on one line. The count of the number of pixels can thus be regarded as the projection value. In the case where a gray image is processed, on the other hand, it is preferable to process an image of which the character image is set to have a higher gradation than the background portion.

The character string to be processed by the character string inspection method according to this invention may not be printed with the characters aligned horizontally depending on the shape of the work on which to print the particular character string. In such a case, the image data for each vertical line on the image to be processed (not necessarily the whole image picked up but an image of a partial area including the character string without fail) is projected on the X-axis by the projection along Y-axis, so that an area corresponding to the width of each character can be cut out. Next, the height and position of the characters in Y-axis direction can be determined by projecting the image data of each character area along the X-axis for each area cut out on the X-axis. In this way, the position and height of the character along Y-axis can be determined.

In the second step, a character area is set individually in accordance with the position of each character cut out, and the height of the character areas can be unified to a value adjusted based on the maximum value of the character height. The height of each character area, though desirably equal to the maximum height of the character, may be set to a value slightly larger than the maximum height.

In the first step, the process of projecting the whole of the object image on X-axis is executed along Y-axis, and thus the range containing the whole character string is cut out. After that, the area of each character may be cut out individually. In this case, the area for each character may be provisionally set based on the result of the first projection.

According to the area setting process in the second step, a variation, if any, of the position of the characters in the character string along Y-axis causes a similar variation in the position of the character areas. Also in the case where the height of the characters are varied due to the deformation, etc. of the character string, on the other hand, the height of each character area is unified based on the maximum height, and therefore the number of horizontal lines can be equalized in each area. As a result, based on the relative positions of the horizontal lines in each character area, the horizontal lines can be set in correspondence with each other between the character areas.

In the third step, the projection value for each horizontal line can be determined by projecting the image data in each character area in the direction along X-axis. Further, an accumulated value of the projection values can be determined for each set of corresponding horizontal lines between the character areas. In this third step, the projection process is executed for all the horizontal lines in each character area, and then the corresponding horizontal lines between the character areas may be combined to accumulate the projection values. Alternatively, after executing the projection process for one set of the horizontal lines, the process of accumulating the projection values may be repeated the number of times equal to the number of sets.

In the second step, the length of the character areas are unified, and therefore in the third step, the accumulated value of the projection values can be determined for all the corresponding horizontal lines in the character areas.

In the area setting process in the second step described above, the character areas of the same height are set for the characters of various height, and therefore the corresponding lines between the character areas after the correction may not correctly reflect the actual print displacement. Basically, however, the print operation is performed by a predetermined number of vertically aligned nozzles, and therefore the height variations between characters are considered small. As long as each dot is expressed by a plurality of pixels, each set of the corresponding horizontal lines between the character areas is considered to contain a multiplicity of horizontal lines associated with the same print line even in the case where the horizontal lines fail to correspond to each other to some degree. By accumulating the projection values for each set of corresponding horizontal lines, therefore, it is possible to obtain the data reflecting the state of each print line of the ink jet printer with high accuracy.

In the fourth step, a print defect along the character string can be determined accurately by using the accumulated value reflecting the print state described above. According to a preferred aspect of the invention, the process of extracting the local maximum value from each accumulation value and the process of comparing the extracted local maximum value with a predetermined threshold are executed in the fourth step. When the result of comparison shows that the local maximum value is larger than the threshold value, it is then determined that a dot jam has occurred in the direction along the character string.

The predetermined threshold value described above can be extracted from the image data of the print line where the dot jam occurred. For example, the projection process is executed along the horizontal line covering the dot jam on the image of the character string that has developed the dot jam, and the projection value thus obtained can be determined as a threshold value. The value taking a margin into account with respect to the projection value obtained can of course be used as a threshold value.

In the case where a dot jam has occurred at a predetermined height, a projection value higher than the normal value is considered to be obtained on the horizontal line of each character corresponding to the defect position. According to this embodiment, the accumulated value for the horizontal line high in projection value is extracted as a local maximum value, and therefore it can be determined with high accuracy whether a dot jam has occurred or not, based on the accumulated value.

Next, according to another preferred aspect of the invention, the fourth step includes the sub steps of adding an accumulated value corresponding to each predetermined range in the direction orthogonal to the character string, comparing the minimum value of the sum obtained by the adding process with a predetermined threshold value, and in the case where comparison shows that the minimum value is smaller than the threshold value, determining that a dot drop has occurred along the direction of the character string.

The predetermined threshold value in this aspect can also be extracted from the image data of the print line which has developed the dot drop. As an alternative, the projection value in the presence of one dot or two on one horizontal line is determined by calculation and the value thus obtained may be used as a threshold value.

In determining a dot drop, the accumulated values are added considering the possibility that the projection value on the horizontal line covering the space between print lines assumes a value approximate to zero. The size of the range for the addition, for example, is set to a value corresponding to the distance between adjacent print lines. Then, the accumulated value for the space is not compared with the threshold value, and the space can be prevented from being determined erroneously as a dot drop. Also, by displacing the range of the addition process by one pixel each time, the determination accuracy can be improved.

In the case where a predetermined print line has developed a dot drop, the projection value for the horizontal lined in the range corresponding to the particular print line is considered to assume a smaller value than normal (approximate to zero in the case of a binary image). In this case, the sum of the accumulated values for each of these horizontal lines assumes a minimum value, which comparison shows is smaller than the threshold value. Thus, a dot drop can be determined with high accuracy.

In the fourth step, both the process of determining the presence or absence of a dot jam and the process of determining the presence or absence of a dot drop are desirably executed.

These determination processes may be executed in such a manner that the numerical values to be compared (local maximum value or the minimum value of the sum) are normalized based on the projection value of a horizontal line on which the maximum number of dots are printed, and compared with a similarly normalized threshold value. In the case where the local maximum value or the minimum value of the sum after normalization is indicated, the user can determine the degree of a dot jam or a dot drop by feeling.

According to a more preferred aspect, in addition to the fourth step, a fifth step is executed in which the length of each character area set in the second step along the direction orthogonal to the character string is compared with a predetermined threshold value, and in the case where comparison shows that the particular length is smaller than the threshold value, it is determined that a dot drop has occurred at the edge of the character string.

In the case where the dot at the upper or lower end of the character string is lacking, the process of cutting out a character in the first step is considered unable to extract the accurate length of the character. The predetermined value in the fifth step can be set based on the length of the character in the absence of one dot-printed line. The length of the character area after correction in the second step is based on the maximum length of each character. By comparing this length with the threshold value described above, therefore, a dot drop, if any, at the upper or lower end of the character string can be determined with high accuracy. This determination is made based not on the length of a specific character but on the maximum value of the character length in order to prevent the erroneous determination which may be caused by a short character like a symbol such as the period.

The printing condition inspection apparatus according to the invention comprises: an image input unit for inputting an image picked up from a print made by a printing head having a plurality of nozzles; a processing range setting unit for setting the processing range of a predetermined width on the image input by the image input unit, in the direction along the print lines and the direction orthogonal to the print lines; an area setting unit for setting, after setting an area specified by the processing range in each direction as a processing area, a plurality of areas along the direction of the print lines in the processing range in each direction; an area adjusting unit for adjusting the position of each area set by the area setting unit in the direction orthogonal to the print lines, based on the relative positions of each area and the printing range on the image, and unifying the length of each area in the direction orthogonal to the print lines, to the length adjusted based on the maximum range of the processing area in the printing range in the direction orthogonal to the print lines; an image processing unit for combining the image data on each line along the direction of the print lines and having corresponding relative positions in the direction orthogonal to the print lines between the areas adjusted by the area adjusting unit, and processing each set of the image data; a determining unit for determining whether a print defect has occurred on each print line using the result of processing each set in the image processing unit; and an output unit for outputting the result of determination by the determining unit.

In this apparatus, the image input unit can include an interface circuit for retrieving the image data on the print or an A/D converter. The processing range setting unit corresponds to the first step, the area setting unit to the second step, the area adjusting unit to the third step, the image processing unit to the fourth step and the determining unit to the fifth step of the printing condition inspection method. These means can be configured of a computer having stored therein a program for executing the corresponding steps.

The output unit may be an interface circuit for outputting the result of determination by the determining unit to an external device. The result of determination is not necessarily a signal simply indicating whether the print has a defect or not, but may output the data indicating the type or the position of a defect.

The printing condition inspection apparatus described above may comprise a binarization device for binarizing the image to be processed. This binarization device may be configured of either a dedicated circuit or a computer in which a binarization threshold and a binarization process is set.

The printing condition inspection apparatus according to a preferred embodiment comprises an input unit for inputting the information for setting the processing range at least in the direction along the print lines, wherein the processing range setting unit sets the processing range in the direction corresponding to the particular setting information input by the input unit.

The character string inspection apparatus according to the invention comprises: an image input unit for inputting an image picked up from a character string printed using a printing head having a plurality of nozzles; a character extraction unit for cutting out each character of the character string from the image input by the image input unit; an area setting unit for setting each character area of equal length in the direction orthogonal to the character string and adjusted to the maximum value of the length of each character cut out by the character extraction unit, in the direction orthogonal to the character string; a projection/accumulation unit for obtaining a plurality of projection values by projecting, along the direction of the character string, the image data in each character area set and accumulating the projection values for each set of corresponding lines between the character areas in the direction orthogonal to the character string; a determining unit for determining whether a print defect exists along the character string using the accumulated value obtained for each set of lines; and an output unit for outputting the result of determination by the determining unit.

In this apparatus, the image input unit and the output unit can be configured the same way as the printing condition inspection apparatus described before. The character extraction unit corresponds to the first step, the area setting unit to the second step, the projection/accumulation unit to the third step, and the determining unit to the fourth step in the character string inspection method described above. These means can be configured of a computer having stored therein a program for executing the corresponding steps.

In the case where the output unit of this character string inspection apparatus indicates the result of determination, the data may be output which include the parameters such as the local maximum value and the local minimum value of the projection value and the height of the area as values corresponding to the threshold values to be compared.

The character string inspection apparatus may further comprise a binarization device for binarizing the image to be processed. In this case, the projection process for the image may be executed to count the number of black pixels or white pixels on one line.

This binarization device, which may be a dedicated circuit as in the aforementioned printing condition inspection apparatus, may be configured of a computer in which a binarization threshold and the binarization steps are set.

According to a preferred aspect of the invention, there is provided a character inspection apparatus, in which the determining unit includes a device for extracting the local maximum value from each accumulated value calculated by the projection/accumulation unit, a device for comparing the extracted local maximum value with a predetermined threshold value, and a device for determining that a dot jam has occurred along the direction of the character string in the case where the comparison shows that the local maximum value is larger than the threshold value. This configuration corresponds to the character inspection method according to the first aspect of the invention.

According to another preferred aspect of the invention, there is provided a character string inspection apparatus, wherein the determining unit includes a device for adding the accumulated value corresponding to each predetermined range along the direction orthogonal to the character string, a device for comparing the sum obtained by the addition process with a predetermined threshold value, and a device for determining that a dot drop has occurred along the direction of the character string in the case where the comparison shows that the sum is smaller than the threshold value. This configuration corresponds to the character inspection method according to the second aspect of the invention.

According to still another preferred aspect of the invention, there is provided a character string inspection apparatus further comprising a second determining unit for comparing the length of each character area set by the area setting unit along the direction orthogonal to the character string with a predetermined value, and determining that a dot drop has occurred at the edge of the character string in the case where the comparison shows that the particular length is smaller than the threshold value. Also, the output unit is adapted to output the data containing the result of determination by the second determining unit. This configuration corresponds to the character string inspection method according to the third aspect of the invention.

The printing condition inspection apparatus and character string inspection apparatus described above can be connected to an image pickup device (camera) for picking up an image of the character string to be inspected and a display device (monitor) for displaying the inspection result. Each time a trigger signal is received from a work detecting sensor or the like, the image pickup device is activated and the image data generated are retrieved thereby to execute each inspection method described above. In this way, it can be determined whether a defect such as a dot jam or a dot drop of the character string of each work has developed or not over a print line. Also, by applying the output from the output unit to a device for removing the defective works or a control device thereof, the work determined to have a print defect can be quickly removed. The defect attributable to the ink jet printer such as a dot jam or a dot drop is liable to develop successively. By applying the output of the output unit to the ink jet printer, however, the print operation can be stopped in response to defect detection.

The peripheral devices such as the image pickup device and the display device can be integrated with the inspection apparatus. Also, the character string inspection apparatus can comprise a means for conducting the character inspection by pattern matching as in the prior art. In this case, the above-mentioned result of inspection on a dot jam or a dot drop is combined with the result of inspection by pattern matching to determine the presence or absence of a defect, and the result of determination is output.

According to this invention, an inspection for a print defect occurring along one print line such as a dot jam or a dot drop can be conducted with high accuracy. Therefore, the character string printed in dots can be inspected from a novel viewpoint unlike in the prior art. A print defect, which may be overlooked by the conventional inspection method using the pattern matching, can be detected with high accuracy.

### BRIEF DESCRIPTION OF THE DRAWINGS

FIG. 1 shows an application of a character string inspection apparatus according to this invention.

FIG. 2 shows an electrical configuration of the character string inspection apparatus.

FIG. 3 shows an example of the image of a character string to be inspected.

FIG. 4 shows a flowchart of a series of inspection steps.

FIG. 5 shows an outline of the process for cutting out a character and the process for provisionally setting a character area.

FIG. 6 shows an outline of the process for extracting the total number of the vertical lines containing black pixels.

FIG. 7 shows a flowchart of the detailed steps of the process shown in FIG. 6.

FIG. 8 shows an outline of the process for correcting the character area.

FIG. 9 shows a flowchart of the detailed steps of the process shown in FIG. 8.

FIG. 10 shows a flowchart continued from FIG. 9.

FIG. 11 shows an outline of the process for accumulating the number of black pixels on corresponding horizontal lines.

FIG. 12 shows a histogram of the result of accumulating the number of black pixels and local maximum values.

FIG. 13 shows a flowchart of the steps of extracting the local maximum values.

FIG. 14 shows a flowchart continued from FIG. 13.

FIG. 15 shows a histogram of the sum of the accumulated values and the minimum value thereof.

FIG. 16 shows a display screen of the determination result.

FIG. 17 shows an example of defects including a dot jam and a dot drop.

### DESCRIPTION OF THE PREFERRED EMBODIMENTS

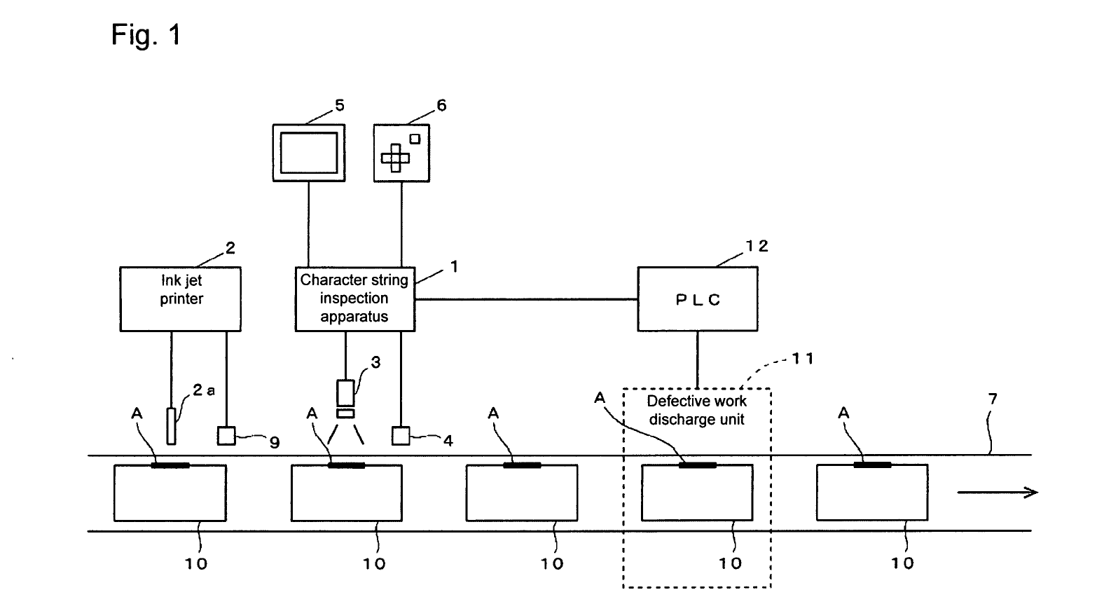

FIG. 1 shows an example of installation of a character string inspection apparatus 1 (hereinafter referred to simply as “the inspection apparatus 1”) according to this invention.

This inspection apparatus 1 is for conducting the inspection on a character string A printed in dots on a predetermined work 10 to check whether a predetermined print line of the character string A has developed a dot jam or a dot drop. In the neighborhood of a conveyor line 7 of the works 10, a CCD camera 3 (hereinafter referred to simply as “the camera 3”) for picking up an image of the character string and a sensor (such as a photoelectric switch) 4 for detecting each work are arranged. The inspection apparatus 1 is installed in position while being connected to peripheral devices such as a monitor 5 and a console 6 as well as the CCD camera 3 and the sensor 4. An ink jet printer 22 for printing the character string is connected to the work detection sensor 9 and installed upstream of the camera 3. Reference numeral 2a designates a printing head of the ink jet printer 2.

A defective work discharge unit 11 (including a discharge conveyor and a defective work recovery box) for discharging the work 10 determined as defective by the inspection apparatus 1 is arranged downstream of the camera 3. The inspection apparatus 1 is connected to a programmable logic controller (PLC) 12 for controlling the operation of the defective work discharge unit 11, and outputs a determination signal indicating whether a particular character string A to be inspected is conforming or nonconforming. The PLC 12, upon receipt of the determination signal indicating “nonconforming”, activates the defective work discharge unit 11 to discharge the defective work 10 out of the conveyor line 7.

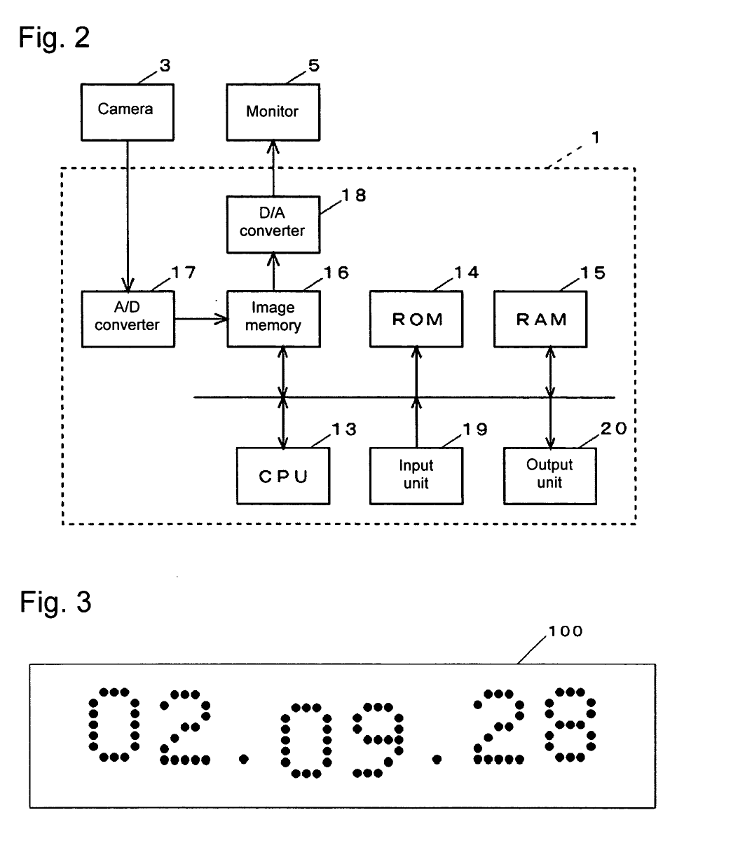

FIG. 2 shows an electrical configuration of the inspection apparatus 1. The inspection apparatus 1, with a CPU 13 as a main control unit, comprises a ROM 14, a RAM 15 and an image memory 16 for storing the gray image data and the binary image data to be processed. The program for executing the inspection steps described later and the program for the binarization process are stored in the ROM 14.

The inspection apparatus 1 further comprises an A/D converter 17, a D/A converter 18, an input unit 19 and an output unit 20. The A/D converter 17 retrieves the image signal from the camera 3 and converts it into a digital signal. The D/A converter 18 converts the digital signal representing the gray image into an analog display signal and outputs it to the monitor 5. The input unit 19 includes an interface circuit for the console 6 and the work-detecting sensor 4, and the output unit 20 includes an interface circuit for the PLC 12.

FIG. 3 shows an example of an image 100 of the character string to be inspected. This character string is printed with the characters thereof not horizontally aligned but irregularly arranged under the effect of the surface conditions of the work 10. In all the specific examples of the process described below, the image 100 constitutes an object to be processed.

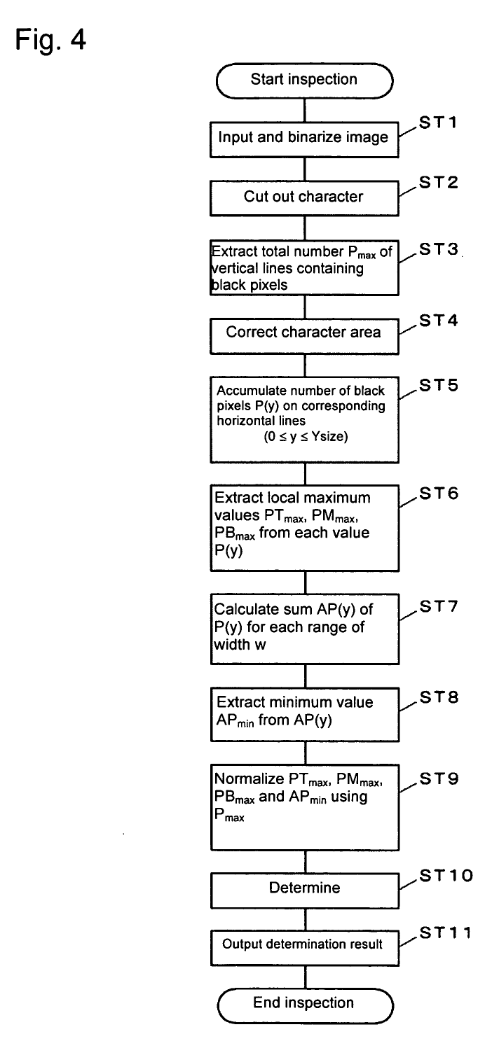

FIG. 4 shows the steps of inspecting one character string. The inspection process is explained in detail below with reference to these steps (which may be abbreviated as ST) shown in FIG. 4 and other drawings if required.

(1) Image Input and Binarization (Step 1)

The process shown in FIG. 4 is started by inputting a work detection signal from the sensor 4. In step 1, the camera 3 is activated to pick up an image of the work 10, and the input image data is binarized. The subsequent process is executed on this binary image.

(2) Cutting Out Character (Step 2)

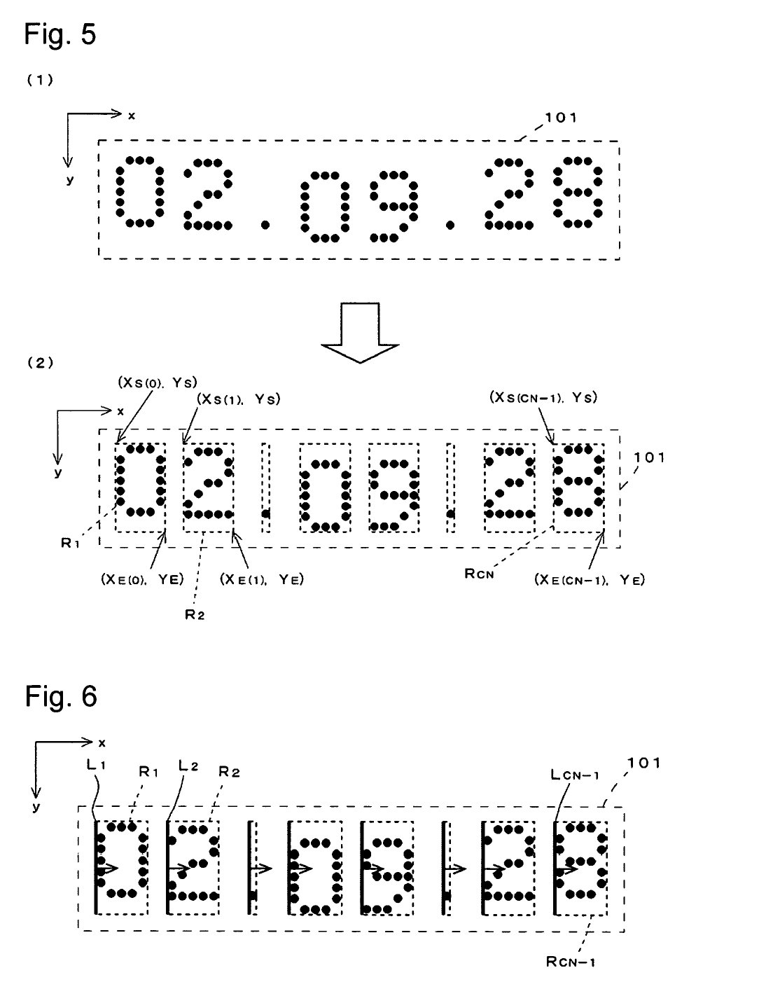

In this step, as shown in FIG. 5(1), a predetermined area to be processed is set on the binary image based on preset data. Specifically, an area 101 to be processed is set in a size sufficient to contain the whole character string on the image. Next, the image data in the area 101 is projected along x and Y-axes thereby to cut out each character contained in the character string. This projection process is executed to count the number of black pixels on one line. As to the x and Y-axes, the X-axis is defined as the direction along the print lines, and the Y-axis the direction orthogonal to the X-axis as shown in the upper left part of FIG. 5. This is also the case with the examples described below.

Further, in step 2, an individual processing area Rn (n: 0, 1, 2, . . . , CN-1, each hereinafter being referred to as “the character area”) is provisionally set for each character based on the cut-out process described above. Character CN designates the number of characters cut out. FIG. 5(2) shows the result of this area setting process. As the result of projecting the image data in the object area 101 along Y-axis, a range corresponding to the width of each character along X-axis can be cut out. Along Y-axis, on the other hand, the range from the upper end position Y_{S} of the character printed at the highest position to the lower end position Y_{E} of the character printed at the lowest position is extracted. In every character area Rn, therefore, the coordinates of the upper and lower ends are set to Y_{S} and Y_{E}, respectively. The set range of each character area Rn is expressed by the coordinate (X_{S}(n), Y_{S}) at the upper left apex and the coordinate (X_{E}(n) , Y_{E}) at the lower right apex.

(3) Extraction of Total Number Pₘₐₓ of Vertical Lines Including Black Pixels (Step 3)

FIG. 6 shows an outline of the process executed in step 3. In step 3, the vertical lines Ln (lines along Y-axis and having a length equal to the height of the character area Rn) included in each character area Rn is sequentially checked and the lines containing black pixels are extracted. The lines containing at least one black pixel are extracted. Further, in step 3, the total of the vertical lines extracted for each character area Rn is determined and set as Pₘₐₓ. This value Pₘₐₓ is used for the normalization process in step 9 described later.

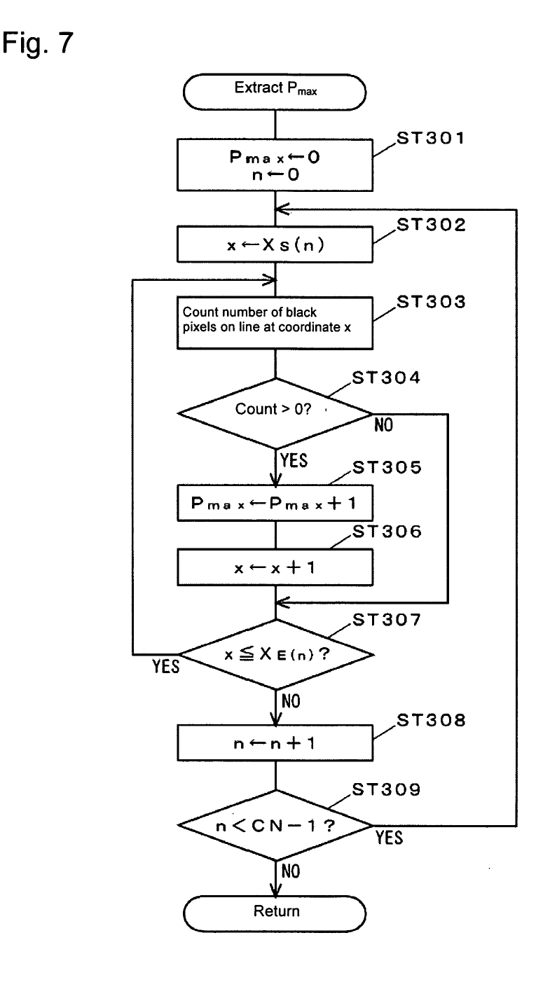

FIG. 7 shows the detailed process of step 3.

In ST301, the counter n indicating the value Pₘₐₓ and the character area involved is set to zero. Next, in ST302, the x coordinate X_{S}(n) of the first line in the character area Rn is checked, followed by ST303 in which the number of black pixels on the vertical line corresponding to the coordinate X_{S}(n) is counted. In the case where this count is larger than zero, the process proceeds from ST304 to ST305, and Pₘₐₓ is updated to the sum of the current value and 1.

While updating the value x up to X_{E}(n) at the right end of this character area, the number of black pixels on each vertical line is counted, and in the case where the count is larger than zero, Pₘₐₓ is incremented. Upon completion of this process for all vertical lines in the character area, the process proceeds from ST307 to ST308 where the value n is updated. Until the determination that the updated value n is not smaller than CN-1 indicating the last character area in ST309, the process is returned to ST302 and the execution of ST302 to ST307 is repeated. In this way, only the vertical lines containing black pixels are extracted from each character area Rn and the total number Pₘₐₓ of the particular vertical lines is calculated

(4) Correction of Character Area (Step 4)

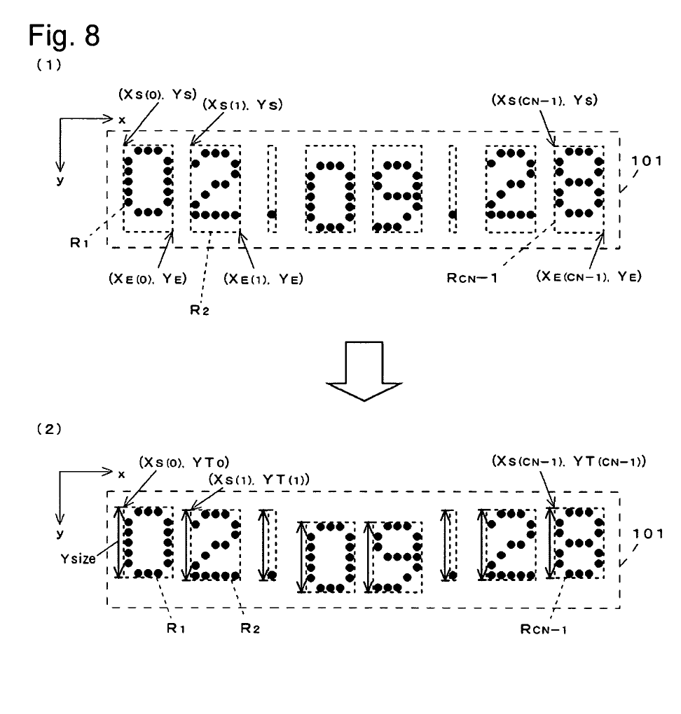

FIG. 8 shows an outline of the process executed in step 4. In step 4, the upper end of the character area Rn provisionally set in step 2 is registered with the upper end of the corresponding character, and the position and height of each character area Rn are corrected in such a manner that the height of each character area Rn (the length of the character area along Y-axis) assumes the maximum value Y_{size} of the height of the corresponding character. The position and size of the character area after correction is expressed by the coordinate (X_{S}(n), YT(n)) at the upper left apex, Y_{size} and the x coordinate X_{E}(n) at the lower right apex.

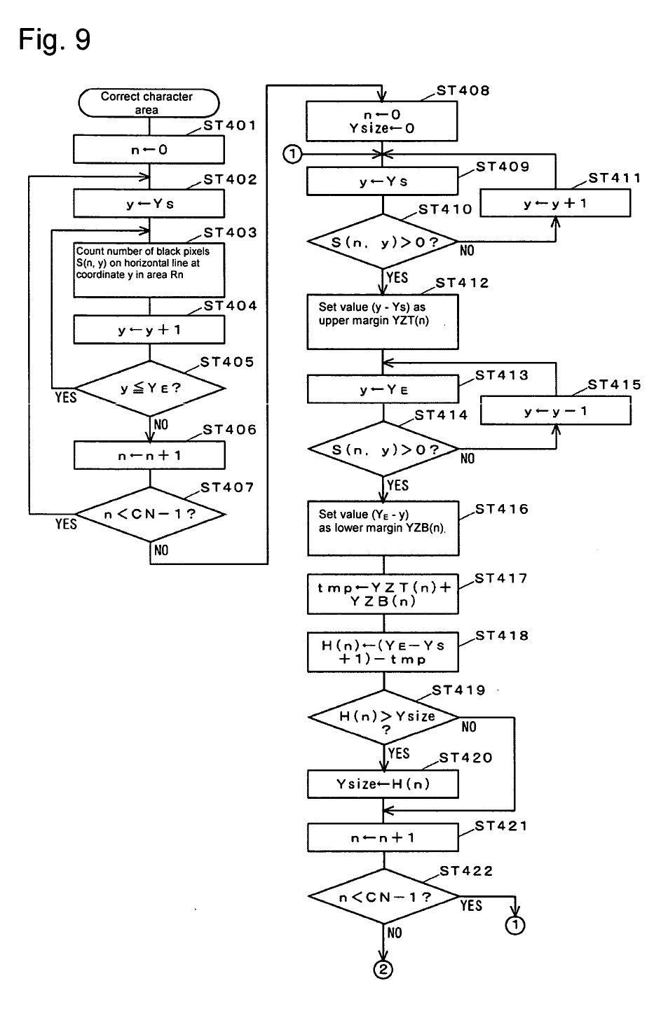

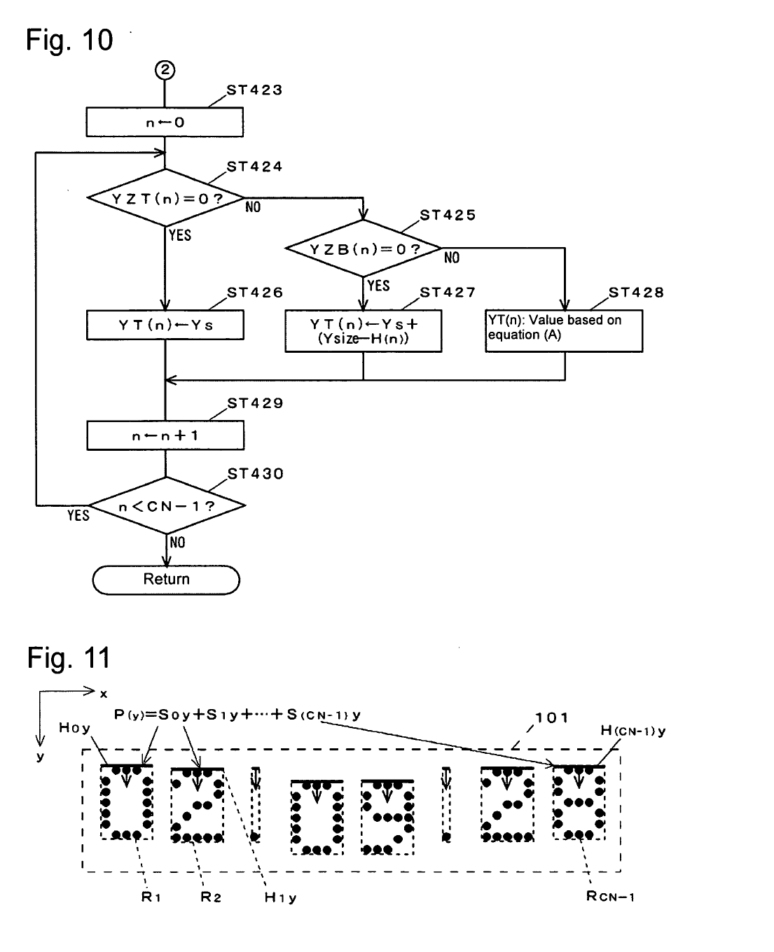

FIGS. 9 and 10 show the detailed process being executed in step 4. FIG. 9 mainly shows the process for extracting Y_{size} and the margin of each character area, and based on these settings, FIG. 10 shows the process for determining the coordinate YT(n) of the upper end in each character area Rn.

First, in ST401, the counter n indicating the character area involved is reset to the initial value of zero, followed by ST402 to ST407 in which the value n is updated, while executing the process for counting the number of black pixels on each horizontal line located at the coordinate y(Y_{S}≦y≦Y_{E}) (i.e. the image data in the area are projected along X-axis). This count is held in the counter n and the RAM 15 as a two-dimensional arrangement data S(n, y) based on the coordinate y indicating the position of the horizontal line to be processed.

Next, in ST408, the value n is reset to zero, and Y_{size} is set to the initial value of zero. After that, the value n is updated while executing the process of ST409 to 422.

The process executed for each character area Rn is explained in detail below.

First, in ST409 to ST411, the character area Rn involved is searched from the upper end downward, and the y coordinate of the first horizontal line for which the number of black pixels S(n, y) is larger than zero is extracted. Once this y coordinate is extracted, the difference between the extracted y coordinate value and the current coordinate Y_{S} indicating the upper end of the character area Rn is determined and set as the upper margin YZT(n) of the character area Rn in ST412.

Next, in ST413 to ST415, the character area Rn is searched upward from the lower end, and the y coordinate of the first horizontal line on which the number of black pixels S(n, y) is larger than zero is extracted. Once this y coordinate is extracted, the difference between the coordinate Y_{E} indicating the lower end of the character area Rn and the extracted coordinate y is determined and set as the lower margin YZB(n) of the character area Rn in ST416.

In ST417, the upper margin YZT(n) and the lower margin YZB(n) set by the above-mentioned steps are added to each other as a total margin tmp. This total margin tmp is a variable shared by the character areas Rn and rewritten each time ST417 is executed.

In ST418, the character height H(n) is determined by subtracting the total margin tmp from the length (Y_{E}−Y_{S}+1) of the current character area Rn. In ST419, the character height H(n) is compared with Y_{size}. In the case where H(n) is larger than Y_{size}, the value Y_{size} is rewritten by the value H(n) in ST420.

Upon completion of the process for the last character area RCN-1 at the end of the loop of ST409 to ST422, the largest one of the character height values should have been set as Y_{size}. These values including Y_{size}, the upper margin YZT(n), the lower margin YZB(n) and the character height H(n) for each character area Rn are held in RAM 15 for the subsequent processes.

Next, in ST423 of FIG. 10, the value n is reset again, and the y coordinate YT(n) indicating the upper end of the character area Rn after correction is determined for each character area Rn by executing the process described below.

First, in ST424, the upper margin YZT(n) of the character area Rn involved is checked. In the case where YZT(n) is zero, i.e. the upper margin is absent, the process proceeds to ST426. In ST426, the coordinate Y_{S} of the current upper end is set as YT(n).

In the case where YZT(n)>0, the process proceeds from ST424 to ST425 and the lower margin YZB(n) is checked. In the case where YZB(n)=0, i.e. there is no lower margin, the process proceeds to ST427. In ST427, the difference between Y_{size} and the height H(n) of the character to be processed is added to the current upper end position Ys of the character area Rn, and the sum is set as YT(n).

In the case where YZB>0, i.e. there are both upper and lower margins in the character area Rn, the process proceeds from ST425 to ST428. In ST428, the values Ys, Y_{size}, H(n), YZT(n) and YZB(n) are applied to equation (A) thereby to calculate YT(n).

$$YT ( n ) = Ys + YZT ( n ) - ( Y size - {H}_{( n )} ) \times \frac{YZT ( n )}{YZT ( n ) + YZB ( n )} \qquad ( A )$$

By the process described above, the coordinate of the upper end of the character area Rn is updated to the value YT(n) adjusted in accordance with the character height and the margin. In all the character areas Rn, the height thereof is unified to Y_{size}. In the character area Rn for which ST426 has been executed, the margin in the size of (Y_{size}−H(n)) is set under the character. In the character area Rn for which ST427 has been executed, on the other hand, the margin in the size of (Y_{size}−H(n)) is set above the character. Further, in the character area Rn for which ST428 has been executed, a margin is set both above and under the character, and the sum of these margins is equal to (Y_{size}−H(n)). Also, both the upper and lower margins are zero in the character areas Rn where H(n)=Y_{size}.

(5) Accumulation of the Number of Black Pixels P(y) on Corresponding Horizontal Lines (Step 5)

The process of step 5 is executed for the character area Rn after the above-mentioned correction, and the outline of the process is shown in FIG. 11. In step 5, the horizontal lines H_{ny} in correspondence with each other between the character areas Rn (the horizontal lines located at the same distance from the upper end of the respective character areas in the range 0≦y≦Y_{size}−1) are sequentially checked, and the number of black pixels S_{0y}, S_{1y}, . . . , S_{(CN-1)y} on each line is determined by executing the projection process for each line. Further, the number of the black pixels for all these lines are accumulated and stored in the RAM 15 as the accumulated value P(Y).

(6) Extraction of Local Maximum Values PTₘₐₓ, PMₘₐₓ, PBₘₐₓ (Step 6)

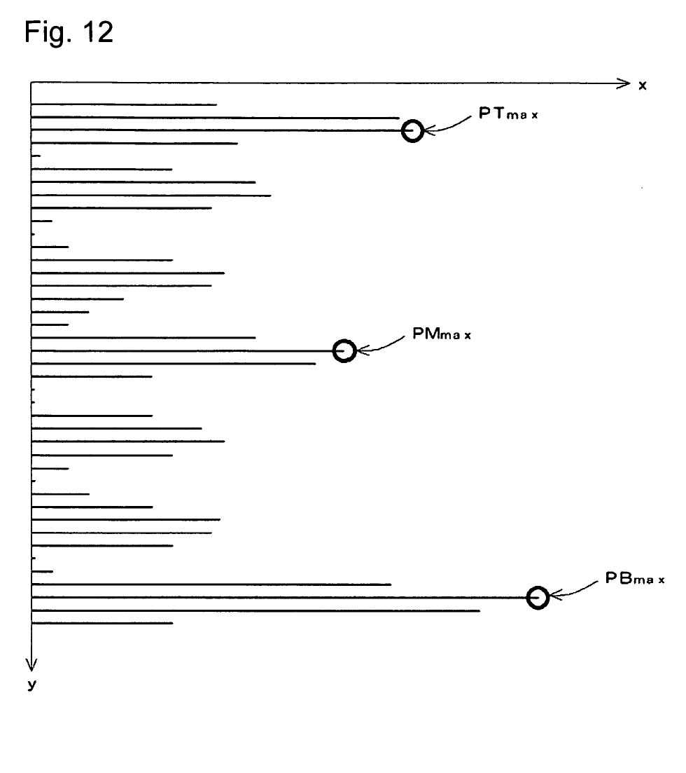

The accumulated value P(y) obtained in step 5, as shown in FIG. 12, can be expressed as a histogram along Y-axis. In step 6, the three local maximum values PTₘₐₓ, PMₘₐₓ and PBₘₐₓ are extracted by scanning this P(y) arrangement. The local maximum value PTₘₐₓ is the one extracted first of all in the process of scanning the histogram from the upper side. The local maximum value PBₘₐₓ, in contrast, is the one extracted first of all in the process of scanning the histogram from the lower side. The local maximum value PMₘₐₓ, on the other hand, is located between the local maximum values PTₘₐₓ and PBₘₐₓ. In the histogram of FIG. 12, the accumulated value P(y) near to zero is considered to reflect the space between the print lines.

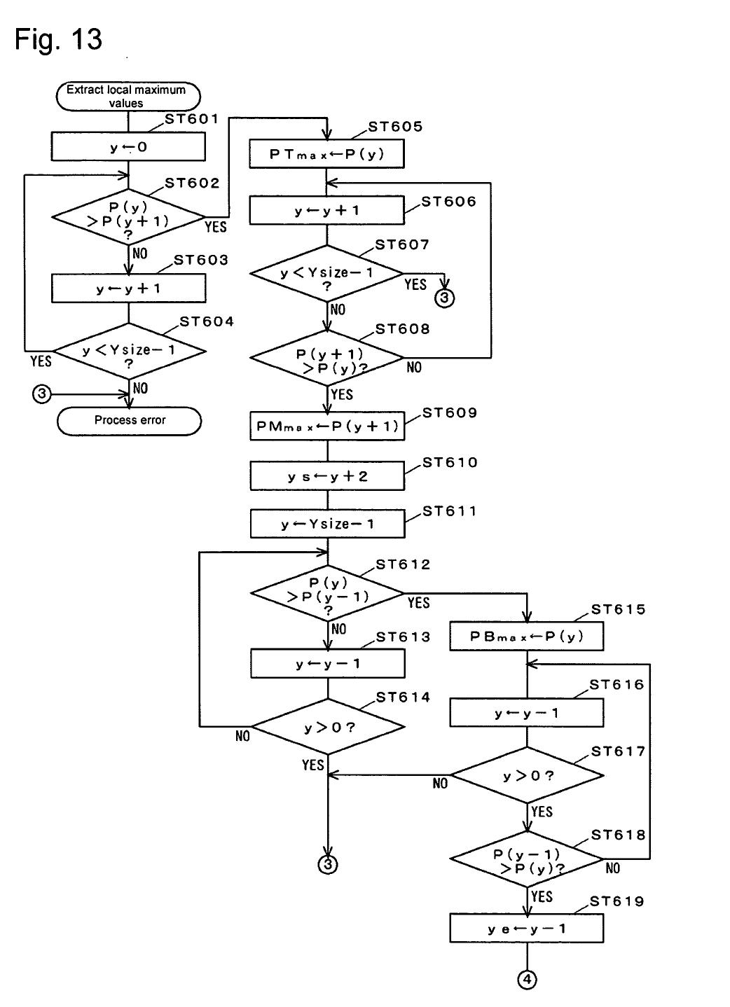

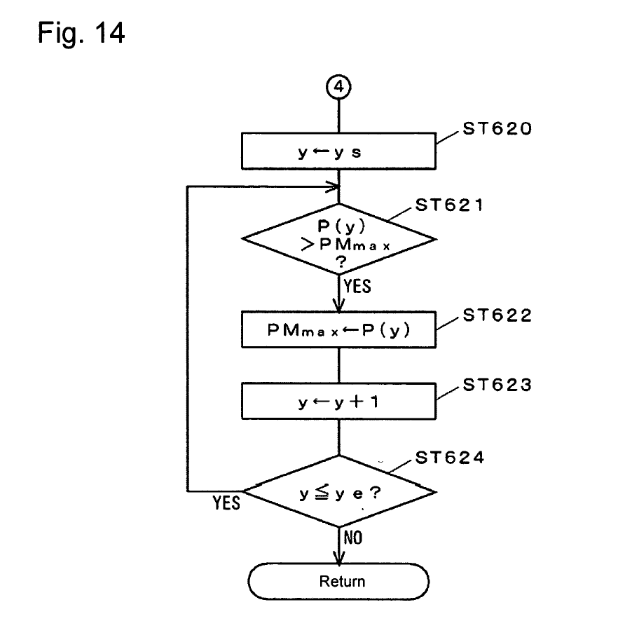

FIGS. 13 and 14 show the detailed process for extracting the local maximum values PTₘₐₓ, PMₘₐₓ and PBₘₐₓ. First in this process, the value y is set to zero to find the local maximum value PTₘₐₓ (ST601). In ST602 to ST604, the value y is incremented by one each time while comparing P(y) and P(y+1) with each other. When P(y) exceeds P(y+1), the value P(y) at position y exceeds both the value P(y+1) at the next lower level and the value P(y−1) at the next higher level. The value (y−1) corresponds to y determined by the previous session of execution of this loop. Also, the current value y is equal to y+1, and comparison between y and y+1 in ST602 shows that the answer is NO (the local maximum value PBₘₐₓ is extracted in similar fashion in ST612 to ST614). As a result, at the time point when the answer in ST602 turns YES, the loop is left and the process proceeds to ST605 where the current value P(y) is set as a local maximum value PTₘₐₓ.

After the local maximum value PTₘₐₓ is set, P(y) and P(y+1) continue to be compared with each other in ST606 to ST608 while scanning the positions lower than where the local maximum value PTₘₐₓ has been obtained. Once P(y+1) exceeds P(y), the process proceeds to ST609, and the value P(y+1) at that time point is set as a local maximum value PMₘₐₓ. The local maximum value PMₘₐₓ at this time point, however, is a provisional one. In the next ST610, the position (y+2) immediately below the local maximum value PMₘₐₓ is held as variable ys for the subsequent process to establish the local maximum value PMₘₐₓ.

Next, in ST611, the value y is set to the maximum (Y_{size}−1). In the following ST612 to ST614, the value y is decreased one by one, while P(y) and P(y−1) are compared with each other. Upon determination that P(y)>P(y−1) in this loop, the process proceeds from ST612 to ST615, where the prevailing value P(y) is set as the local maximum value PBₘₐₓ.

After the local maximum value PBₘₐₓ is set, P(y) and P(y−1) are compared with each other above the local maximum value PBₘₐₓ in ST616 to ST618. In the case where P(y−1) exceeds P(y), the loop is left to proceed to ST619, and the prevailing value (y−1) is set as a variable ye. In ST620 to ST624, the value y is changed one by one in the range of ys to ye, while the maximum value of P(y) is extracted in this range. This value is set as the local maximum value PMₘₐₓ.

In the case where the local maximum value is not found in the range covered by each loop in ST602 to ST604, ST606 to ST608, ST612 to ST614 and ST616 to 618, the process proceeds to the error-processing step not shown.

(7) Addition of P(y) (Step 7)

The accumulated value P(y) is processed also in step 7. The process of step 7 corresponds to the process of adding each accumulated value P(y) included in the range of predetermined width w along Y-axis of the histogram. This adding process is executed while changing the value y one by one from 0, and therefore the sum determined for each value y is stored as AP(y)

(8) Extraction of Minimum APₘᵢₙ (Step 8)

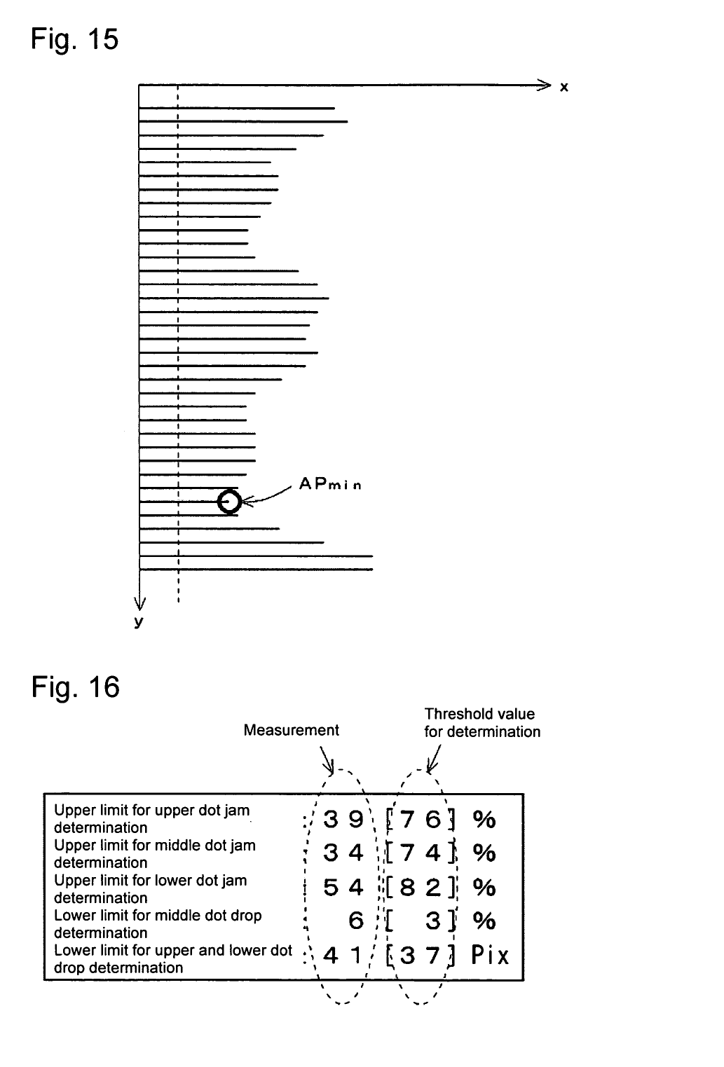

FIG. 15 shows the sum AP(y) obtained in the preceding step 7 as a histogram along Y-axis in similar fashion to FIG. 12 (shown in reduced scaled along X-axis). In step 8, the sums AP(y) are sequentially compared to determine the minimum value APₘᵢₙ.

(9) Normalization Process (Step 9)

In step 9, the local maximum values PTₘₐₓ, PMₘₐₓ, PBₘₐₓ and the minimum value APₘᵢₙ of the sum obtained in the foregoing processes are normalized using the value Pₘₐₓ obtained in ST3. In normalizing the local maximum values PTₘₐₓ, PMₘₐₓ and PBₘₐₓ, the current value is divided by Pₘₐₓ. In normalizing the minimum value APₘᵢₙ of the sum, on the other hand, the current value is divided by Pₘₐₓ×w, where w is used for indicating the range of calculation of the sum AP(y).

The value Pₘₐₓ indicates the total number of vertical lines on which at least one black pixel appears in correspondence with a dot in each character area Rn. Each value after normalization, therefore, is considered to indicate the ratio which the black pixels actually appear represent of the maximum number of black pixels that can appear on one horizontal line.

(10) Determining Step (Step 10)

In step 10, each of the values after normalization of the local maximum values PTₘₐₓ, PMₘₐₓ, PBₘₐₓ and the minimum value APₘᵢₙ of the sum is compared with a predetermined threshold value. The threshold value for each local maximum value reflects the number of black pixels on the print line that has developed a dot jam. In the case where any one of the local maximum values increases beyond the threshold value, a dot jam is considered to have occurred at the position corresponding to the particular local maximum value.

The threshold value corresponding to the minimum sum APₘᵢₙ reflects the number of black pixels on a horizontal line corresponding to one print line to which about one dot or two is applied. In the case where the value APₘᵢₙ after normalization is lower than the threshold value, it is determined that a dot drop has occurred at the position corresponding to APₘᵢₙ.

The value APₘᵢₙ is for extracting dots drop on the print lines other than those at the upper and lower ends. In ST10, the determining process is executed also using the height Y_{size} of the character area Rn after correction in order to determine a dot drop on the upper and lower end lines.

As described above, Y_{size} represents the maximum height of the characters in each character string. In the case where a dot drop occurs on the print line at the upper or lower end, therefore, the value Y_{size} is considered to assume a value lower than the original value equal to the character height.

According to this embodiment, therefore, a threshold value is set based on the character height lacking one print line and compared with Y_{size}. In the case where Y_{size} is smaller than the threshold value, it is determined that a dot drop has occurred on the upper or lower end print line.

(11) Determination Result Output (Step 11)

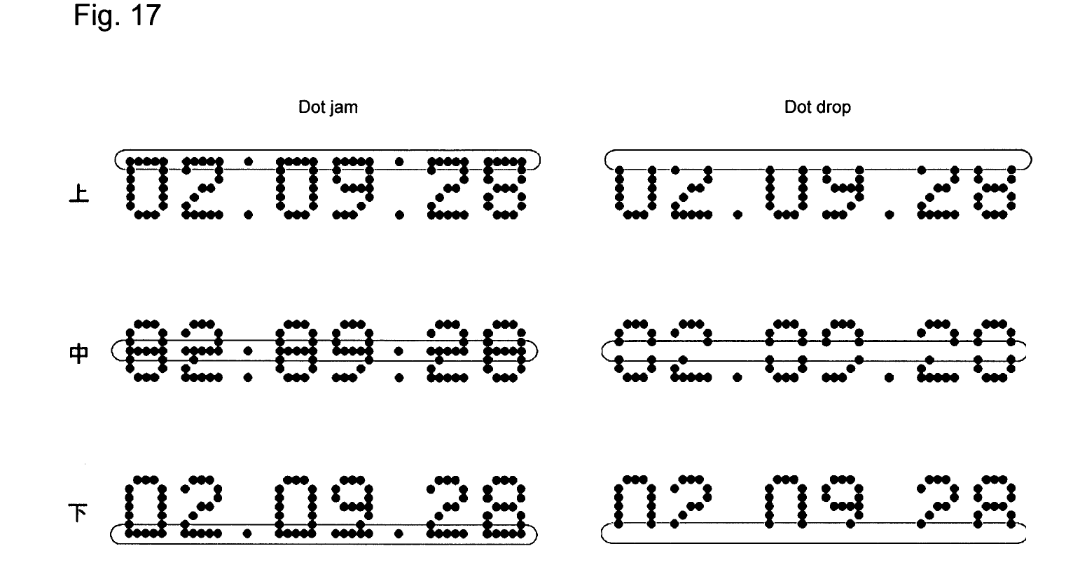

Upon determination in step 10 that a dot jam or a dot drop has occurred at any position, a determination signal indicating “a defect is output” to the PLC 12 in step 11. In step 11, the determination result display screen is displayed on the monitor 5 as shown in FIG. 16.

In FIG. 16, the upper limit for upper dot jam determination, the upper limit for middle dot jam determination and the upper limit for lower dot jam correspond to the local maximum values PTₘₐₓ, PMₘₐₓ and PBₘₐₓ, respectively. The lower limit for middle dot drop determination corresponds to the minimum value APₘᵢₙ of the sum AP(y), and the lower limit for upper and lower dot drop determination in the lowest stage corresponds to Y_{size}.

In the shown case, these five parameters are displayed in correspondence with the measurements obtained by the process described above and the threshold values used for the determining process. Each numerical value of PTₘₐₓ, PMₘₐₓ, PBₘₐₓ and APₘᵢₙ represents the one after normalization expressed in percentage, and the numerical value of Y_{size} the number of pixels.

In the process described above, the character area Rn of each character in the character string is adjusted in accordance with the position of the particular character on Y-axis, while at the same time adjusting the height of each character area Rn to the largest height Y_{size} of the character. Therefore, the correspondence of the horizontal lines H_{ny} between the character areas Rn can be established smoothly, and the accumulated values P(y) in the number of Y_{size} can be obtained.

It is of course true that the character height is varied and a margin is set for the character of small height, and therefore the corresponding horizontal lines between the character areas Rn cannot be said to reflect the actual correspondence faithfully. Since each dot on the image is as large as several pixels, however, it may be that a multiplicity of combinations of horizontal lines can be set for the same print line and a multiplicity of combinations of horizontal lines can be set for the same space between the print lines. Based on the accumulated value P(y), therefore, a sufficiently reliable data can be obtained on the prints of each print line. Also, based on the local maximum values and the minimum values, the presence or absence of a dot jam or a dot drop can be determined with high accuracy.

With regard to the dot drop, the determination process is executed using the minimum value APₘᵢₙ of the sum of the accumulated values P(y) for the range of a predetermined width w, and therefore the space portion between the print lines can be prevented from being erroneously extracted as a dot drop. In addition, according to this embodiment, the determination process is executed using the value Y_{size} extracted for correction of each character area, and therefore the dot drop at the upper and lower ends can be determined with high accuracy.

The width w described above can be determined by picking up an image of a model character string free of a print defect. In this case, the value Y_{size} is determined for each character by executing the process similar to steps 1 to 4 in FIG. 4, and this value Y_{size} is divided by the number of print lines. Based on the resultant quotient, the value w can be set. Also, in this case, the inspection process of FIG. 4 is executed first based on a set value, and in accordance with the minimum value APₘᵢₙ, the value w is desirably adjusted. In the case where the space between the print lines is small, for example, the minimum value APₘᵢₙ may increase. In such a case, the value w is adjusted downward. In the case where the space between the print lines is large, on the other hand, the minimum value APₘᵢₙ may decrease, in which case the value w is adjusted upward.

Also, as shown in FIG. 16, the dot jam or the dot drop is indicated by the ratio, which it represents of the maximum number of black pixels on one horizontal line, the relation between the printed condition and the numerical values can be easily grasped. The threshold value for the determination process in ST10 can be numerically input by the user.

Instead of processing the binary image in the inspection apparatus 1 according to this embodiment, the gradation image after analog-to-digital conversion may be processed. In this case, the process of counting the black pixels in steps ST2, ST303 and ST403 is replaced by the process of adding the density value of each pixel on the line. Step ST3 is executed to extract the vertical line containing the pixels having a density corresponding to the character image.

In the case where the number of pixels having a density value corresponding to the gradation character image is counted instead of adding the density value as described above, the data similar to those for the projection value of the binary image can be obtained.

Further, in the inspection apparatus 1 according to this embodiment, the character inspection can be conducted also by pattern matching as in the prior art. By conducting the inspection in a plurality of ways as described above, the print defect attributable to various causes can be detected for remarkably increased inspection accuracy.

The embodiments described above fail to refer to the case in which each character in the character string is deformed. Depending on the tilt of the printing surface, however, the print line may be deformed along the width of even a single character. In such a case, the area along the character string is subdivided into smaller units than the width of one character and a similar process is executed. Also, the width of each area is desirably set in accordance with the degree of deformation of the character to be processed.

In the aforementioned embodiments, the character string is processed. Also in the case where the print other than the character such as a mark is inspected, however, a similar inspection method can be employed.

1. A printing condition inspection method for picking up an image of a print made using a printing head having a plurality of nozzles and inspecting whether a print defect has occurred in the print line of each nozzle using the image picked up, comprising:
a first step for setting the processing range of a predetermined width on the image of the print in the direction along the print lines and the direction orthogonal to the print lines;
a second step for setting a plurality of processing areas specified by the processing range set in the first step along the direction of the print lines;
a third step for adjusting the position of each area set in the second step in the direction orthogonal to the print lines based on the relative positions of each area and the printing range on the image and unifying the length of each area in the direction orthogonal to the print lines to the length adjusted based on the maximum range of the processing areas;
a fourth step for combining the image data on each line along the direction of the print lines in corresponding relative positions along the direction orthogonal to the print lines between the areas after adjustment in the third step, and processing each set of the image data; and
a fifth step for determining whether a print defect has occurred on each print line using the result of processing each set in the fourth step.

2. A printing condition inspection method according to claim 1,
wherein the first step includes the substep of receiving the input of the information for setting the processing range at least in the direction of the print lines and setting the processing range in the direction corresponding to the input information.

3. A character string inspection method for picking up an image of a character string printed using a printing head having a plurality of nozzles and checking whether a print defect has occurred along the character string using the image of the character string, comprising:
a first step for cutting out each character making up the character string to be processed from the image of the character string;
a second step for setting each of a plurality of areas, for each of the characters cut out in the first step, having an equal length in the direction orthogonal to the character string and adjusted by the maximum length of the characters in the direction orthogonal to the character string;
a third step for acquiring a plurality of projection values by executing, for each character area, the process of projecting the image data in the area along the direction of the character string and accumulating the projection values for the respective sets of the lines in correspondence with each other between the character areas in the direction orthogonal to the character string; and
a fourth step for determining whether a print is defective or not along the character string using each accumulated value obtained in the third step.

4. A character string inspection method according to claim 3,
wherein the fourth step includes the sub steps of extracting the local maximum value from each accumulated value, comparing the extracted local maximum value with a predetermined threshold value, and in the case where comparison shows that the local maximum value is large than the threshold value, determining that a dot jam has occurred along the direction of the character string.

5. A character string inspection method according to claim 3,
wherein the fourth step includes the sub steps of adding the accumulated values corresponding to a plurality of predetermined ranges along the direction orthogonal to the character string set in the second step, comparing the minimum value of the sum obtained by the addition with a predetermined threshold value, and in the case where the sum is smaller than the threshold value, determining that a dot drop has occurred along the direction of the character string.

6. A character string inspection method according to claim 3,
wherein the fifth step includes the sub steps of comparing the length of each character area set along the direction orthogonal to the character string in the second step with a predetermined threshold value, and in the case where comparison shows that the length is smaller than the threshold value, determining that a dot drop has occurred at the edge of the character string.

7. A printing condition inspection apparatus comprising:
an image input unit for inputting an image picked up from the print made using a printing head having a plurality of nozzles;
a processing range setting unit for setting a processing range of a predetermined width on the image of the print, in the direction along the print lines and the direction orthogonal to the print lines;
an area setting unit for setting an area specified as a processing area by the processing range in each direction, and setting a plurality of processing areas along the direction of the print lines in the processing area;
an area adjusting unit for adjusting the position of each area set by the area setting unit in the direction orthogonal to the print lines, based on the relative positions of each area and the printing range on the image, and unifying the length of each area in the direction orthogonal to the print lines to the length adjusted based on the maximum range of the processing areas in the printing range in the direction orthogonal to the print lines;
an image processing unit for combining the image data on each line along the direction of the print lines having corresponding relative positions in the direction orthogonal to the print lines between the areas after adjustment by the area adjusting unit, and processing each set of the image data thus combined;
a determining unit for determining whether a print defect has occurred on each print line using the result of processing each set in the image processing unit; and
a output unit for outputting the result of determination by the determining unit.

8. A printing condition inspection apparatus according to claim 7, further comprising an input unit for inputting the information for setting the processing range at least in the direction along the print lines,
wherein the processing range setting unit sets the processing range in the direction corresponding to the setting information input from the input unit using the same setting information.

9. A character string inspection apparatus comprising:
an image input unit for inputting an image picked up from a character string printed using a printing head having a plurality of the nozzles;
a character extraction unit for cutting out each character making up the character string from the image input by the input unit;
an area setting unit for setting, for each character cut out by the character extraction unit, each of a plurality of character areas having an equal length in the direction orthogonal to the character string and adjusted by the maximum value of the length of the characters in the direction orthogonal to the character string;
a projection/accumulation unit for acquiring a plurality of projection values by executing, for each character area, the process of projecting the image data in the direction of the character string in the character area set by the area setting unit, and accumulating the projection values for each set of the lines in correspondence with each other between the character areas in the direction orthogonal to the character string;
a determining unit for determining whether a print defect exists along the character string, using each accumulated value obtained by the projection/accumulation unit for each set of the lines; and
an output unit for outputting the result of determination by the determining unit.

10. A character string inspection apparatus according to claim 9,
wherein the determining unit includes a device for extracting the local maximum value from each accumulated value calculated by the projection/accumulation unit and a device for comparing the extracted local maximum value with a predetermined threshold value, and
wherein in the case where comparison shows that the local maximum value is larger than the threshold value, it is determined that a dot jam has occurred along the direction of the character string.

11. A character string inspection apparatus according to claim 9,
wherein the determining unit includes a device for adding the accumulated values corresponding to each predetermined range along the direction orthogonal to the character string and a device for comparing the minimum value of the sum obtained by the addition with a predetermined threshold value, and
wherein in the case where the comparison shows that the sum is smaller than the threshold value, it is determined that a dot drop has occurred along the direction of the character string.

12. A character string inspection method according to claim 9,
wherein further comprising a second determining unit for comparing the length along the direction orthogonal to the character string of each character area set by the area setting unit with a predetermined threshold value, and in the case where the comparison shows that the length is smaller than the threshold value, determining that a dot drop has occurred at the edge of the character string,
wherein the output unit is adapted to output the data including the result of determination by the second determining unit.
